(19) United States
(12) Patent Application Publication
(10) Pub. No.: US 2019/0265375 A1
(43) Pub. Date: Aug. 29, 2019

(54) Cloud Framework System

(71) Applicant: Schlumberger Technology Corporation, Sugar Land, TX (US)

(72) Inventors: Ahmed Adnan Aqrawi, Tananger (NO); William Havalah Gillock, Houston, TX (US); Reishin Toolsi, Houston, TX (US); Jan Dolejsi, Gatwick (GB); Mohamed Benaichouche, Oslo (NO)

(21) Appl. No.: 16/341,440

(22) PCT Filed: Dec. 18, 2017
(86) PCT No.: PCT/US2017/066913

§ 371 Date: Apr. 11, 2019

Related U.S. Application Data
(60) Provisional application No. 62/435,935, filed on Dec. 19, 2016.

(51) Int. Cl. G01V 1/30; G06F 9/50; G01V 1/28; G01V 1/34

(52) U.S. Cl. CPC G01V 1/301; G06F 9/5072; G01V 2210/74; G01V 1/345; G01V 1/282

(57) ABSTRACT

A method can include receiving a request for cloud resources where the cloud resources include frameworks where the frameworks include a seismic interpretation and earth model framework; processing the request; accessing at least one of the frameworks as executing on at least a portion of the cloud resources; generating a result responsive to the accessing; and transmitting the result.

### BACKGROUND

In the field of resource extraction, seismic data acquisition and analysis can allow for construction of a more accurate model of a subterranean environment, which, in turn, may facilitate development, resource extraction, etc.

### SUMMARY

A method can include receiving a request for cloud resources where the cloud resources include frameworks where the frameworks include a seismic interpretation and earth model framework; processing the request; accessing at least one of the frameworks as executing on at least a portion of the cloud resources; generating a result responsive to the accessing; and transmitting the result. A cloud system can include servers where each of the servers includes a processor and memory accessible by the processor; data storage devices accessible by the servers; processor-executable framework instructions for a plurality of frameworks stored in the data storage devices where the frameworks include a seismic interpretation and earth model framework; processor-executable application programming interface instructions for the frameworks; and processor-executable common interface instructions for a common interface that is a proxy that exposes the frameworks to the Internet. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a system;

FIG. 3 illustrates an example of an architecture;

FIG. 4 illustrates an example of a device and an example of a graphical user interface;

FIG. 5 illustrates an example of a table;

FIG. 6 illustrates an example of a system;

FIG. 7 illustrates an example of a method;

FIG. 8 illustrates an example of a device, an example of a graphical user interface and an example of a method; and

FIG. 9 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

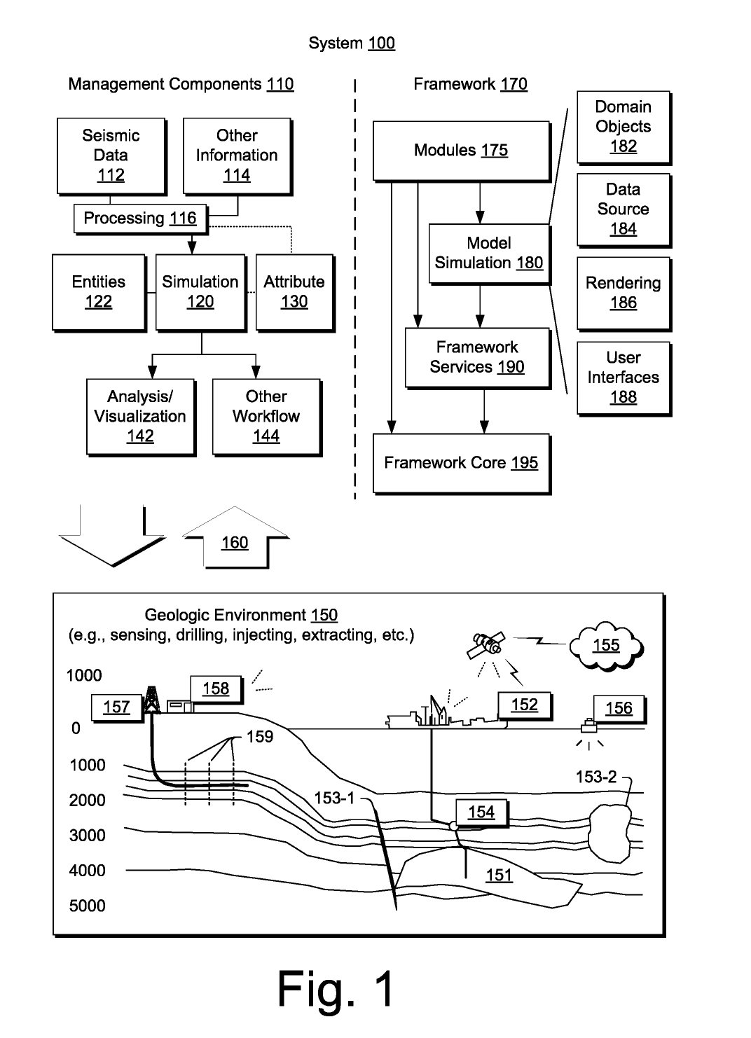

FIG. 1 shows an example of a system 100 that includes various management components 110 to manage various aspects of a geologic environment 150 (e.g., an environment that includes a sedimentary basin, a reservoir 151, one or more faults 153-1, one or more geobodies 153-2, one or more fractures 159, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE® reservoir simulator (Schlumberger Limited, Houston Tex.), the INTERSECT® reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.). The PETREL® framework can be considered to be a seismic interpretation and earth model framework.

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® framework that hosts OCEAN® framework applications. In an example embodiment, the PETREL® framework may be considered a data-driven application.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include the reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with the one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® framework, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

As an example, data may be acquired from using seismic sources, seismic sensors, borehole tools, etc. A workflow can include generation and recording of seismic data. Acquisition of seismic data, which may be according to a seismic survey, can involves one or more types of receiver configurations, including laying geophones or seismometers on the surface of the Earth or seafloor, towing hydrophones behind a marine seismic vessel, suspending hydrophones vertically in the sea or placing geophones in a wellbore (as in a vertical seismic profile) to record seismic signals. A source, such as a vibrator unit, dynamite shot, or an air gun, can generate acoustic or elastic vibrations that travel into the Earth, pass through strata with different seismic responses and filtering effects, and return to the surface to be recorded as seismic data.

As an example, a borehole tool may be positioned to acquire information in a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework (Schlumberger Limited, Houston, Tex.).

As an example, a framework may include one or more components for simulation of an operation or operations associated with drilling. For example, the DRILLBENCH® dynamic drilling simulation framework (Schlumberger Limited, Houston, Tex.) can provide for planning and forecasting drilling operations including, for example, fluid dynamics simulation associated with drilling and drilling fluids. As an example, such a framework can include a dynamic hydraulic model that can account for temperature transients for calculating factors such as wellbore pressure. Such a framework may be implemented in a well control workflow, which may cover pressure control, well control, blowout control, etc. Dynamic simulations of fluid(s) during drilling, circulation, state periods, etc. may be performed to generate simulation results. Simulation results may include pore and fracture pressures and consider mud characteristics for one or more types of wells (e.g., deepwater, extended-reach, high pressure and high temperature (HPHT), etc.).

As to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.). As an example, data may be provided via a storage medium, via wire, via wireless circuitry, etc. For example, a computing system may receive and/or access data via a storage medium, via wire, via wireless circuitry, etc.

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As mentioned, the OCEAN® framework can include various features for interactions with one or more other frameworks. The OCEAN® framework includes various application programming interfaces (APIs), which can allow for extending capabilities, access to features, etc. As an example, a plugin may be utilized via one or more APIs. A plugin may implement one or more algorithms that automate data analysis processes.

As to particular APIs, consider a fluid API, which may allow for workflows for analyzing and describing hydrocarbon fluids and/or water found in petroleum reservoirs. The fluid API can allow a reservoir engineer to execute a workflow that can include reservoir simulation. For a production engineer, the fluid API can allow for analyses in well completion design. As an example, a workflow can include programmatically creating a black-oil fluid model and a compositional fluid model, which may involve exposing functionality via the fluid API. The OCEAN® framework fluid API can be used in different types of plugin workflows, such as guided workflow plugins, plugins that check quality of the fluid data, or plugins that modeling hydraulic fracturing.

As an example, an API can be a rock physics API. Modeling rock mechanics for a reservoir simulation helps to understand the interaction between fluids and the reservoir rock. Various functions of saturation, or pressure used in simulation represent physics of fluids and rock. Various OCEAN® framework APIs can allow for programmatically creating saturation, compaction, and adsorption functions. The rock physics API can provide for creating plugins that can extend the PETREL® framework to support various methods of simulation such as enhanced oil recovery (EOR).

As an example, an API can be a simulator API. For example, consider an API that assists in adding a specific simulator to a workflow. A simulator may support a format or formats that can be plugged into the PETREL® framework.

As an example, an API can be a grids API. For example, gridding in reservoir simulation can turn a geological model of a field into a discrete system on which the fluid flow equations can be solved by a solver (e.g., a simulator, etc.). As an example, a grid can be a pillar grid that represents a reservoir model. The construction of pillar grid reservoir models can be facilitated by the processes in the interactive grid construction tool set in the PETREL® framework. A grids API can enables the creation and manipulation of grids. As an example, cell property representations can be manipulated through the OCEAN® grid API (e.g., to create, read, update, and delete). As an example, a pillar fault API can enable modeling of reservoirs that include faults. In the OCEAN® framework, the pillar grid API allows for plug-ins that can assist with grid creation and manipulation. Such an API can also allow for performing quality control (QC) of grid data (e.g., to ensure that it is ready for simulation).

As an example, an API may be a development strategy API. For example, development strategies facility can tell a simulator how a field will be developed, which wells will produce, or inject, what the pressure rate controls and limits are, what operations will be carried out on the wells over time, etc. As an example, simulation setup can involve specifying one or more development strategies. In the OCEAN® framework, one or more strategy domain objects can provides functionality to access development strategy collection, create/delete strategy, and read access to name and description. In the OCEAN® framework, a development strategies namespace allows for providing types to create, read, and edit development strategy, and work with the control date, wells, groups, and rules folders. As an example, a development strategy API can allow for creation of plugins to create and assess development strategies.

As an example, an API can be a results and charting API. For example, such an API can allow for visualization and charting functionality that facilitates presentation and QC of simulation results.

As an example, an API can be a completion-level observed data API. Such an API may provide for production monitoring and surveillance. Completion-level data can help to evaluate inflow and outflow performance at one or more depth ranges, which can have one or more flow rates associated therewith (e.g., between reservoir and wellbore). As an example, such an API can allow for evaluation of the intervals that may not be performing adequately and, for example, to facilitate decision making for remedial action(s). Completion-level data may be accessed via a well and reservoir analysis framework data connector or, for example, through a split manager (e.g., for use of split sets). With a completion-level observed data API, a plug-in can automate import of data from one or more third-party vendors to create completion level observed data sets. As an example, data sources can be from spreadsheet, SQL servers, etc. As an example, for a production history in the PETREL® framework, as a completion level observed dataset, it can be used in a well section graphical user interface panel to display production alongside completion and log data in a preconfigured production track, as well as used in the production bubble mapping and production mapping processes.

As an example, a split sets API may be utilized where split sets are can be created, accessed, analyzed, etc. As an example, consider a workflow that can back-allocate wellbore production by splitting well-level observed data into completion intervals. The OCEAN® framework API for split sets allows for creation, editing, and deleting splits sets in a PETREL® framework project. Such an API can allow for creating a plugin that imports zonal allocations from an external data source and creating split sets with wells, perforations, and factors based on the imported data. As an example, a split set can then be applied to the well-level observed data, which can generate a completion-level dataset that can then be used with the production analytics function, such as the well section window production track, production bubble mapping, and production mapping processes. As an example, a workflow can include implementing one or more splitting algorithms, for example, in an algorithm list in a split manager interface.

The OCEAN® framework can include, for example, framework specific APIs (e.g., PETREL®, TECHLOG®, AVOCET®, ECLIPSE®, DRILLBENCH®, etc.), OCEAN® framework common services APIs and OCEAN® framework core functionality APIs. As mentioned, the OCEAN® framework can be built using a software framework that includes one or more class libraries (e.g., Framework Class Library (FCL), etc.) and that can provide language interoperability (e.g., a language can use code written in one or more other languages) across several programming languages. As an example, programs written for the .NET framework can execute in a software environment known as the Common Language Runtime (CLR), an application virtual machine that can provide services such as security, memory management, and exception handling. Code written using .NET framework is referred to as managed code.

The .NET framework includes a family of .NET platforms targeting mobile computing, embedded devices, alternative operating systems and browser plugins. A reduced version of the framework, .NET compact framework, is available on WINDOWS® CE platforms, including mobile devices such as smartphones. Another version, .NET micro framework, targets embedded devices. SILVERLIGHT® is available as a web browser plugin. MONO™ is available for various operating systems and is customized into smartphone operating systems (e.g., ANDROID® and iOS®) and console engines. The .NET core targets cross-platform and cloud-based workloads in addition to the Universal Windows Platform (UWP).

As mentioned, various frameworks may be available for acquiring, handling and/or processing data. The TECHLOG® framework can dynamically incorporate data from a wellsite (e.g., for review and detailed analysis). Data can be streamed directly from a wellsite for real-time processing and instantaneous analysis as the well is drilled, aiding decision making during operations.

As an example, a petrophysicist may access the TECHLOG® framework to leverage high-resolution data to examine orientation of fractures as well as evaluating resistive qualities of those fractures to understand fluid flow in and around the wellbore. The TECHLOG® framework can facility 3D interpretations of data collected in one or more wells. A well model can be used to create a multiwell interpretation that provides input to a simulation model to evaluate dynamic behavior in the reservoir.

Another example of a framework is the AVOCET® framework (Schlumberger Limited, Houston, Tex.), which can connect global and remote operations for a broad range of disciplines—field staff, production and reservoir engineers, production accountants, and administrators. The AVOCET® framework can collect, store, and display various types of production operations information-surface, wellbore, wellhead, and facilities data—with measurements—well test data, fluid analyses, transfer tickets, and tank inventories—to enable users to view and track forecasts, production targets, budgets, and other KPIs at a corporate, business unit, or geographical level. With cross-domain workflows and integration with other platforms and products, users can see asset performance in a single environment, for example, to understand the impact of changing production conditions, etc.

By combining data and measurements acquired in production operations with simulation models, the AVOCET® framework can provide technical insight into reasons for production interruptions and shortfalls. As an example, integration with well and reservoir analysis can deliver a ready flow of data into the PETREL® framework for tasks such as reservoir simulation model building, editing, etc., and simulation to help users understand how changing production conditions may influence production. With data and models united in the single environment of the AVOCET® framework, the root cause of one or more problems may be identified more quickly, resulting in minimized downtime and optimized production. Additional operations solutions for enhanced monitoring and surveillance are available to help assess production—from multiphase metering to surveillance and pipeline management.

As an example, a system can allow for enablement of remote web-service access to various resources through the use of a framework such as, for example, the OCEAN® framework. Such a system can allow for control of applications running in a cloud environment. In such an example, by providing a web-service layer between a mobile device and an application, remote access and control of the application can occur as well as, for example, an ability to control remote devices through the application.

As an example, a scenario can include controlling a device with another mobile device through one or more cloud enabled services and streaming data back to the application as well as utilization of multi-platform software development kit to enable plugin developers to also author mobile device apps.

As an example, a web-service layer can be implemented for a suite of frameworks running in a cloud environment to enable communication and connection to remote devices and, for example, various types of workflows, which can include various types of interaction patterns. As to some examples of interactions, one can remotely control and command the software through a mobile device and one can use software to communicate to a remote device. As an example, several devices can communicate with one another through a web-service layer and stream data to one or more software platforms/applications

With constant uptime availability via a cloud environment, individuals can do work and collaborate without having to be on a desktop computer (e.g., workstation) and in front of a display where one or more graphical user interfaces of a framework are being rendered. Collaboration and process can be more user-friendly and efficient when accessible remotely. For example, consider: verifying an interpretation while not in office/on travels; starting workflows remotely from an out-of-office location and reviewing results when back in the office; starting a workflow from a desktop computer and receiving notifications on a mobile device (e.g., at desired times, according to events, etc.); adding annotations; running and monitoring simulation cases; etc.

As an example, a web-service can enable: running framework functionality on one or more remote devices; an ability to create simplified UIs with alternative interaction patterns, such as touch, for specific functions; create alternative UIs to reuse information and feedback (streamline modules); extending a knowledge database and collaboration functions to mobile devices (collaborate on the go); live data streaming from external devices from the field (e.g., remote imaging, borehole measurements, VSP, production data, etc.); etc.

As an example, frameworks can execute using cloud environment resources, which may be public and/or private resources, which have services and infrastructure to support remote connections.

As an example, OCEAN® framework web-service hooks can operate based on one or more events of other frameworks (e.g., applications) and expose them through a remote connection protocol (RPC) and one or more APIs (e.g., for remote devices, etc.). Such an approach can involve an ability to listen to events and respond, and to invoke events/commands remotely.

As an example, remote devices can use a connection protocol to contact one or more applications and stream display information live (e.g., real-time). As an example, a remote device can communicate commands through an API to web-service, which then can translate them to commands for one or more other devices or to one or more applications.

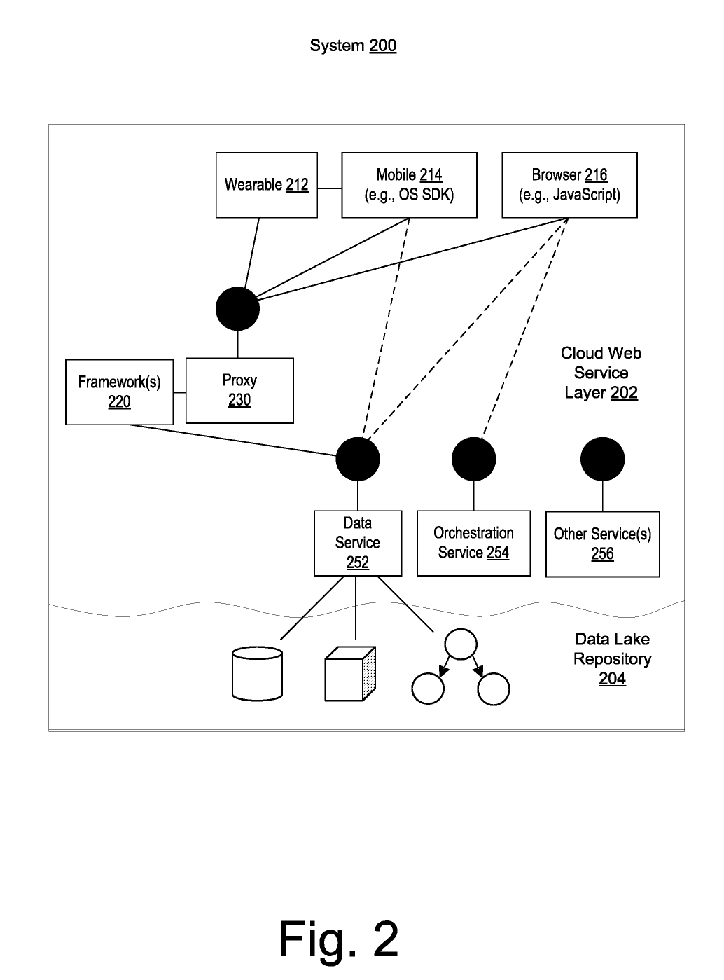

FIG. 2 shows an example of a system 200 that includes a cloud Web service layer 202 and a data lake repository 204. As shown in the example of FIG. 2, devices such as wearable devices 212, mobile devices 214 and browser enabled devices 216 can access one or more services in the cloud Web service layer 202. For example, data services 252, orchestration services 254 or other services 256 may be accessed as may be part of the data lake repository 204. As to one or more frameworks 220, access by one or more of the devices 212, 214 and 216 can be via a proxy 230.

In the example of FIG. 2, the one or more frameworks 220 are hosted in a cloud environment. As an example, consider one or more of the following frameworks: OCEAN®, PETREL®, ECLIPSE®, INTERSECT®, TECHLOG®, PETROMOD®, AVOCET®, DRILLBENCH®, one or more other frameworks mentioned herein, one or more other frameworks, etc. In the cloud environment, which may be public, private or a hybrid of public and private resources, a framework may execute on a physical machine (e.g., a server) and optionally using one or more virtual machines, for example, via a virtualization platform. As an example, instances of a framework may be generated in an on-demand manner, whether as a machine dedicated instance and/or as a virtual machine instance.

In computing, a server can be a computer program or a device that provides functionality for one or more other programs or devices (e.g., client devices). A client—server model can provide for computing distributed across multiple processes, devices, etc. Servers can provide various functionalities (e.g., services, such as sharing data or resources among multiple clients, or performing computation for a client). A single server may serve multiple clients, and a single client may use multiple servers.

In the example of FIG. 2, data may be secure in the data lake repository 204. For example, the devices 212, 214 and 216 may be able to access information that includes data or that is based at least in part on data in the data lake repository without being able to modify or delete the data.

As an example, the proxy 230 of the system 200 of FIG. 2 can also be a proxy for site devices that can be provisioned via an Internet of Things (IoT) hub. In such an example, the proxy 230 may operate as an interface for receipt of calls from applications (e.g., apps) running on the devices 212, 214 or 216.

The Internet is the global system of interconnected computer networks that use the Internet protocol suite (TCP/IP) to link devices worldwide. It is a network of networks that includes private, public, academic, business, and government networks of local to global scope, linked by a broad array of electronic, wireless, and optical networking technologies. The Internet carries an extensive range of information resources and services, such as the inter-linked hypertext documents and applications of the World Wide Web (WWW or “Web”), electronic mail, telephony, and peer-to-peer networks for file sharing.

As an example, the proxy 230 can be a common interface for at least the frameworks 220. As an example, the proxy 230 can be a common interface for the frameworks 220 and one or more sets of IoTs, which may be site specific IoTs. The availability of IoTs for a site can allow for control, monitoring, data acquisition, etc., depending on the nature of the devices that constitute the IoTs. As an example, a site device can be a sensor with communication circuitry that allows the device to be provisioned in a registry of a cloud platform. As an example, a site device can be a controller with communication circuitry that allows the device to be provisioned in a registry of a cloud platform.

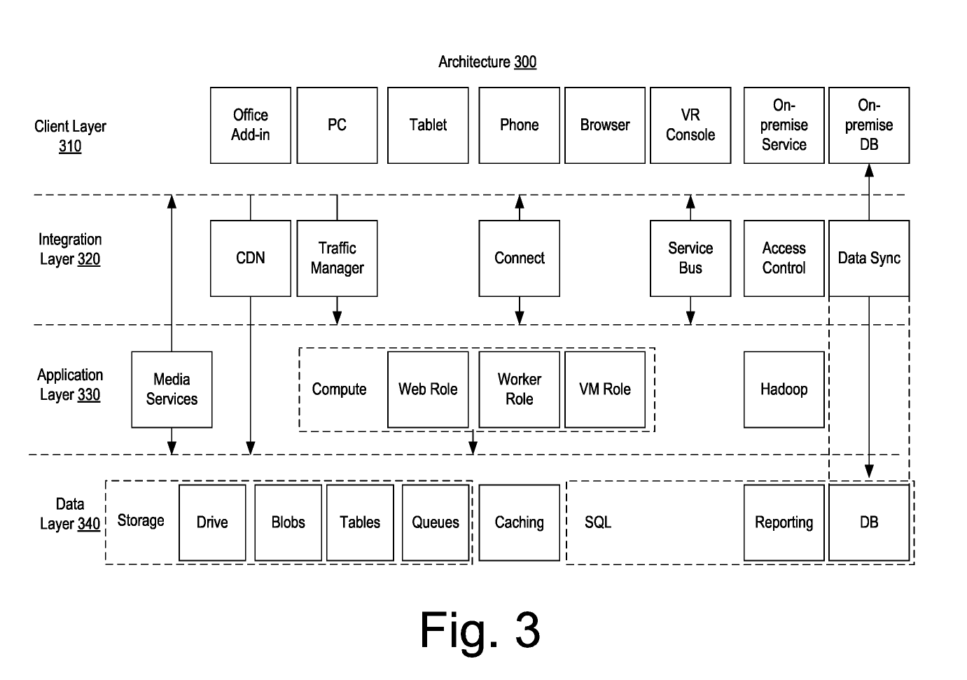

FIG. 3 shows an example of a cloud architecture 300, which corresponds to the AZURE® platform architecture (Microsoft Corporation, Redmond, Wash.). As shown, the architecture 300 includes a client layer 310, an integration layer 320, an application layer 330 and a data layer 340. The client layer 310 can include features for one or more of the devices 212, 214 and 216 of the system 200. The integration layer 320 can provide logistics as to Web-based connections and communications with the client layer 310 and with the application layer 330 and/or the data layer 340.

As shown in the example of FIG. 3, the application layer 330 can include media services and compute resources, which can include Web role, worker role and virtual machine (VM) role compute resources, which can be operatively coupled to the data layer 340. As shown, the data layer 340 can include various data storage features (e.g., drives, blobs, tables, queues, etc.), caching features and database access features (e.g., SQL, etc.).

As an example, a cloud computing platform can be utilized to implement a cloud-based system. For example, consider the AZURE® platform (Microsoft Corporation, Redmond, Wash.), which is a cloud computing platform and infrastructure for building, deploying, and managing applications and services through a global network of data centers.

A cloud computing platform can offer, for example, virtual machines, infrastructure as a service (IaaS) that provide for launch of virtual machines and/or preconfigured machine images, App services, a platform as a service (PaaS) environment (e.g., to publish and/or manage Web sites), Websites, high density hosting of websites (e.g., optionally using one or more of ASP.NET, PHP, Node.js, Python, etc.), etc. As an example, a cloud-based system may utilize Websites in PHP, ASP.NET, Node.js, Python, or one or more other languages. As an example, a cloud computing platform may offer WebJobs as applications that can be deployed to a Web App to implement background processing. Such an approach may be invoked on a schedule, on-demand and/or run continuously. As an example, a cloud computing platform may offer blob (data storage/structure), table and queue services, which may be utilized to communicate between Web Apps and WebJobs and, for example, to provide state information.

A cloud computing platform can provide one or more of SaaS, PaaS and IaaS services and, for example, supports different programming languages, tools and frameworks.

Cloud computing can allow users to benefit from various computing technologies, optionally without deep knowledge about or expertise with each one of them. Cloud computing can reduce, manage and/or control costs. Implementation in a cloud environment can help a service provider to focus on business instead of being impeded by IT obstacles.

As mentioned, cloud services can dynamically scale, for example, to meet demands of users. Provisioning may be automated in a cloud environment where a cloud infrastructure provider supplies hardware and software.

Could computing can be defined in part via the following three application categories: infrastructure as a service (IaaS), platform as a service (PaaS) and software as service (SaaS). Various frameworks may be exposed via the Internet, which can allow client devices to use various technologies as a service in the cloud.

As an example, a cloud environment can provide an “Internet of Things” (IoT) hub. For example, an IoT hub can provide for adding devices, connecting to existing devices, using device SDKs for multiple platforms, including LINUX® OS, WINDOWS® OS, and real-time operating systems (RTOSs). As an example, an IoT hub can scale from just a few devices (e.g., sensors, etc.) to hundreds of simultaneously connected devices (e.g., sensors, etc.) with distributed availability of the cloud.

As an example, a device can be a sensor device, a control device, or other device that may include an embedded microcontroller with an operating system (e.g., a RTOS, etc.). As an example, a wearable device can be a client device and a sensor device, a control device, etc. As an example, a wearable device can include communication circuitry that allows for communication via one or more protocols. For example, consider BLUETOOTH® communication circuitry that communicates via a BLUETOOTH® protocol and/or WiFi communication circuitry that communicates via an Internet protocol (IP).

As an example, a field site may be instrumented with various types of devices that include communication circuitry that allows for access via a network or networks that include or operatively coupled to the Web. As an example, a field site may be a seismic survey field site, a rigsite, etc. As an example, a rigsite can be a wellsite where a well exists, as may be drilled according to a well plan. For example, a well plan can specify a well trajectory and optionally completion specifications. As an example, a well plan may specify a treatment such as a stimulation treatment. Various types of equipment can be present at a rigsite, which may be a wellsite, where such equipment can be control and/or sensor equipment that can form part of an IoT infrastructure at the site.

As an example, a wearable device or a mobile device can include communication circuitry that accesses cloud resources, which, in turn, can access one or more other devices, which may include, for example, one or more devices of an IoT infrastructure.

As an example, a worker may be at a rigsite with a wearable device, such as goggles with a display and a camera, and view equipment at the rigsite where such equipment may be part of an IoT infrastructure operatively coupled to the Web and cloud resources. Information sensed by the camera of the wearable device may be communicated to the Web where cloud resources access information acquired via an IoT infrastructure and transmit such information (e.g., raw or processed) back to the wearable device for rendering to the display of the wearable device. As an example, the wearable device may include a microphone that can receive a user's voice for voice recognition (e.g., local and/or remote) that can command a graphical user interface and/or other features associated with the wearable device and/or remote features as may be associated with resources in the cloud and/or of an IoT infrastructure.

As an example, a wearable device and/or a mobile device may communicate directly with equipment of an IoT infrastructure at a site or, for example, may be configured to communicate via a cloud platform where the cloud platform manages provisioning, security, etc. as to the equipment of the IoT infrastructure at the site. In such an example, a user may manage interactions with equipment at a site via the cloud platform. Further, in such an example, the user may interact with one or more other user devices (e.g., client devices) via the cloud platform.

As an example of a workflow, consider a user at a wellsite where a hydraulic fracturing operation is being performed. In such an example, the user can have a tablet device as a client device that is operatively coupled to the Web with access to a cloud platform that hosts various frameworks. At the wellsite, a pump truck can include IoT equipment such as, for example, a pressure sensor and a pressure controller. The user may access a framework such as, for example, the MANGROVE® framework (Schlumberger Limited, Houston, Tex.), which provides for engineered stimulation design via the PETREL® framework. The MANGROVE® framework includes a hydraulic fracturing simulator that can integrate petrophysical analysis, complex fracture engines, and comprehensive geomechanics in a comprehensive, end-to-end workflow. The MANGROVE® framework includes a 3D finite-element geomechanical simulator and enables an operator to simulate fracture initiation and diversion, as well as all geomechanical changes during fracturing and production, which can allow for making decisions to maximize production. The user may instruct an instance of the MANGROVE® framework in the cloud to perform an analysis that generates results. Such results may be communicated to the tablet device of the user, optionally as text, images, etc. In turn, the user may access, via the cloud platform, the IoT equipment associated with the pump truck and instruct the IoT equipment, for example, to change a pressure (e.g., a flow rate, etc.).

As an example, a cloud architecture can include one or more API management tools. For example, consider the AZURE® API management tool, which includes the following components: (a) an API gateway that is an endpoint that can accept API calls and routes them to backends; can verify API keys, JWT tokens, certificates, and other credentials; can enforce usage quotas and rate limits; can transform an API on-the-fly (e.g., without code modifications); can cache backend responses where set up; and can log call metadata for analytics purposes; (b) a publisher portal that is an administrative interface to set up an API program to, for example, define or import API schema, package APIs into products, set up policies like quotas or transformations on the APIs, get insights from analytics, and manage users; and (c) a developer portal that can serve as a Web presence for developers such that developers (e.g., as authorized) can access API documentation, test an API via an interactive console, create an account and subscribe to get API keys, and access analytics on their usage.

As an example, an API can be a common API that can expose directly and/or indirectly functionality of a plurality of different frameworks and optionally other resources, whether local to a cloud environment or remote from a cloud environment (e.g., site-based equipment, GIS services, etc.). A common API may expose such resources in a mobile-friendly manner that may allow for app developers to customize workflows and/or to develop apps that can customize workflows for one or more scenarios and/or to select a workflow or workflows as associated with one or more scenarios.

As an example, an API management service can be utilized to create an API façade (e.g., an API layer, etc.) for a diverse set of devices and associated services. As an example, an API layer can include an API developer portal, which may provide documentation and samples, metering support, protection from abuse and overuse, monitoring, tracking, analytics, etc. As an example, one or more pieces of equipment that may be site equipment may include instructions executable on a processor of the equipment that allows the equipment to generate one or more API calls to an API layer, which may, return information to the equipment and/or to one or more other devices. For example, a piece of equipment may utilize an API to make calls that cause resources in a cloud environment to report information to a client device. As an example, consider a pressure sensor at a site that may reach a pressure limit and, in response, transmit an API call to an API layer of a cloud environment where the API layer transmits the call to a framework and where the framework generates a result that is transmitted from the cloud environment to one or more client devices (e.g., via the API layer). In such an example, the pressure sensor can provide a framework with information (e.g., data) that may be utilized in a simulation (e.g., in real-time or near real-time) that can generate simulation results that can be reported to one or more addresses associated with one or more client devices and/or individuals that may be responsible for one or more operations at the site.

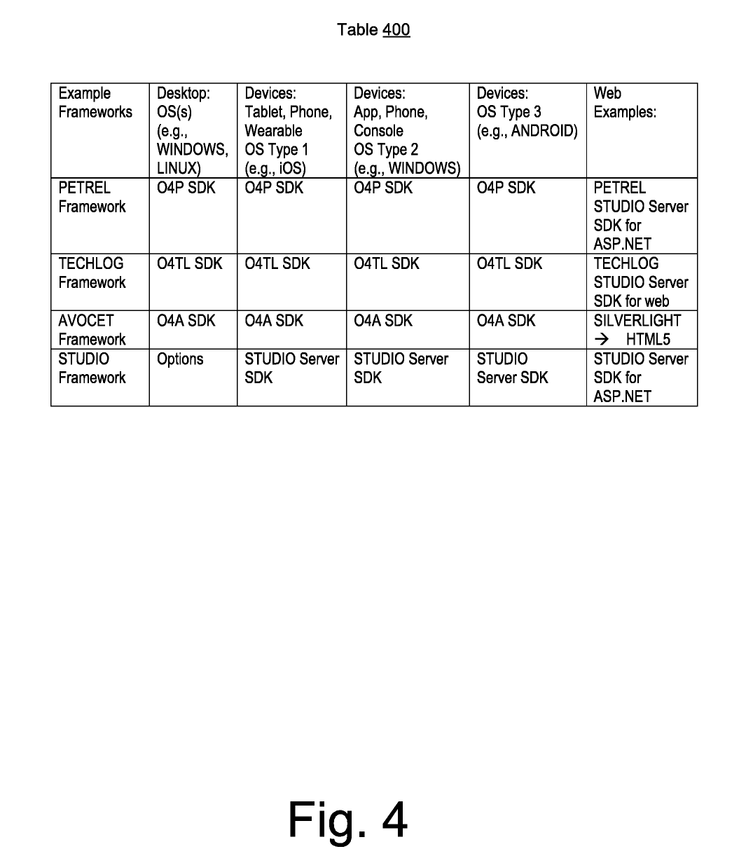

FIG. 4 shows an example of a device 400 that is a client device with a processor, memory accessible by the processor, a display operatively coupled to the processor and communication circuitry (e.g., one or more network interfaces). The device 400 can include an operating system, which may be a mobile operating system (e.g., iOS®, ANDROID®, WINDOWS®, etc.). The device 400 can include a browser application and/or one or more other applications that can provide for access to a cloud platform via the Web (e.g., via WiFi, cellular, satellite, etc.).

As shown in the example of FIG. 4, the device 400 has a graphical user interface 410 rendered to its display that shows a portion of a field as a plan view that includes well pads with well trajectories and equipment such as a pump truck that includes a conduit to one of the well pads for purposes of pumping water (e.g., stimulation fluid) into the well to generate one or more hydraulic fractures, which may be generated in one or more stages.

As an example, a workflow can include detecting the device 400 at a site, accessing a cloud platform, associating the device 400 with the site and resources associated with the site, transferring data (e.g., image data, graphics, etc.) to the device 400 from the cloud platform, rendering information to the display of the device 400, receiving a command by the cloud platform via user interaction with the device 400 (e.g., where an user interaction may be via touch, voice, stylus, etc.), accessing the cloud platform to determine resources accessible remotely by the device 400 (e.g., according to permissions, group, company, etc.) and transmitting information to the device 400 where the graphical user interface 410 of the device 400 can present graphical controls for interaction with the determined resources that are accessible remotely by the device 400.

As shown in the example of FIG. 4, resources available through the cloud platform include a stimulation framework 422 for a well (well Y) and a stage (stage Z) and various IoT equipment at the site 424, including a pump truck (pump truck X) and proppant supply (e.g., mass, concentration, flow, etc.). In such an example, the pump truck can include various equipment such as one or more meters, one or more pressure sensors, one or more controllers, etc.

The user of the device 400 may access the stimulation framework 422 for the well and the stage, which may be executing in real-time based on information acquired by the cloud platform for one or more ongoing stimulation operations at the site. In turn, the user of the device 400 may assess results received via the cloud platform as to at least one of the ongoing stimulation operations at the site and access the pump truck as part of the IoT 424 to enter a control parameter that can be communicated to the cloud platform and then to the pump truck at the site. In such an example, the control parameter, which can represent a change in control of the pump truck, can be communicated from the cloud platform to one or more other user devices, for example, based on a proximity to the pump truck, a proximity to the site, a role of a user, a type of device, etc. Thus, in such an example, a control action effectuated via a cloud platform can be communicated to one or more other devices (e.g., client devices) to keep people informed as to a change or changes in operation(s) at a site. As mentioned, a pressure sensor may be a “smart” sensor with a processor and a network interface (e.g., an IoT sensor) that allows the pressure sensor to transmit information (e.g., as an API call or other type of transmission) to a cloud platform where such information may be transmitted to one or more resources that execute a framework such as the stimulation framework 422. In such an example, a simulation result that is based at least in part on the pressure sensor information may automatically be transmitted to the device 500.

The foregoing example workflows may be referred to as cloud platform mediated workflows. Such a workflow or workflows can include directing communications through a cloud platform, which may, log such communications for purposes of forensics, reporting, regulations, learning, etc. In various foregoing examples, resources accessed include a framework, particularly a stimulation framework. Such a framework can be accessed via one or more APIs, which may cause resources in a cloud environment as managed via a cloud platform to perform one or more tasks (e.g., accessing an executing instance of the framework, instantiating an instance of a framework, etc.).

As an example, the device 400 can include an accelerometer, a gyroscope, etc., which may allow for movement based instructional input. For example, where an earth model framework can provide views of the earth model, a device such as the device 400 may be moved in a manner that can generate instructions for transmission to a cloud environment to cause the earth model framework to generate a view as transmittable information that can be transmitted to the device 400 for rendering on a display of the device 400. As an example, such information may be an image, vector graphics, a combination of image and vector graphics information, etc. As an example, where the device 400 includes one or more graphical processing units (GPUs), such information may be received by the cloud environment and information generated by the framework may be in a format suitable for input and rendering by the one or more GPUs of the device 400.

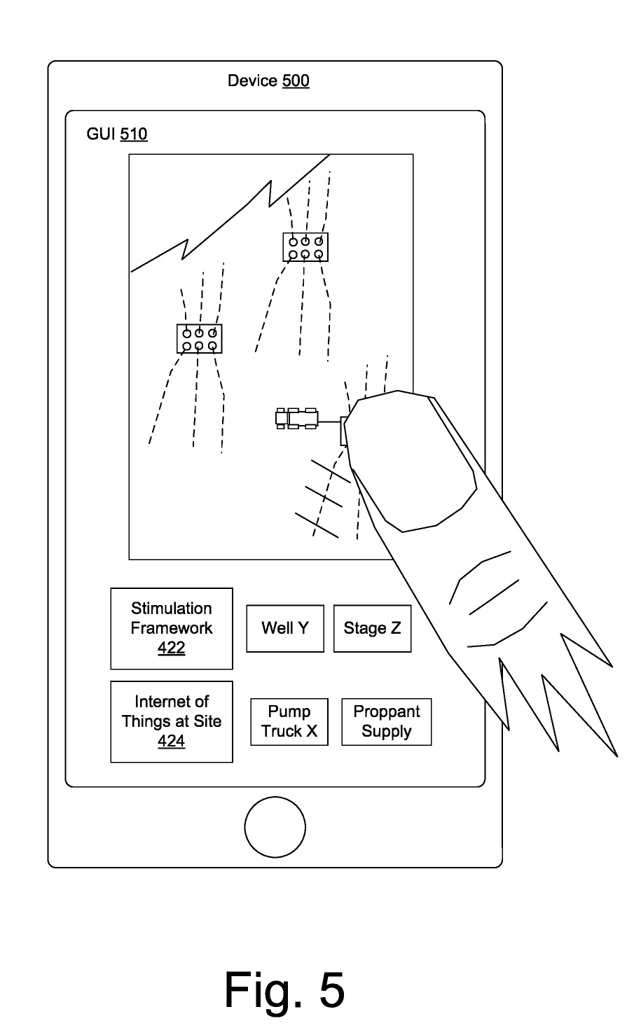

FIG. 5 shows an example of a table 500 that includes a listing of some examples of frameworks that can be executed in a cloud environment and managed by a cloud platform. As an example, a software development kit (SDK) may be a single SDK, for example, based on XAMARIN™ technology (Microsoft Corporation, Redmond, Wash.). For example, consider Xamarin.iOS (previously named MonoTouch), which is a library that allows developers to create C# and .NET™ framework based applications that can run on various devices.

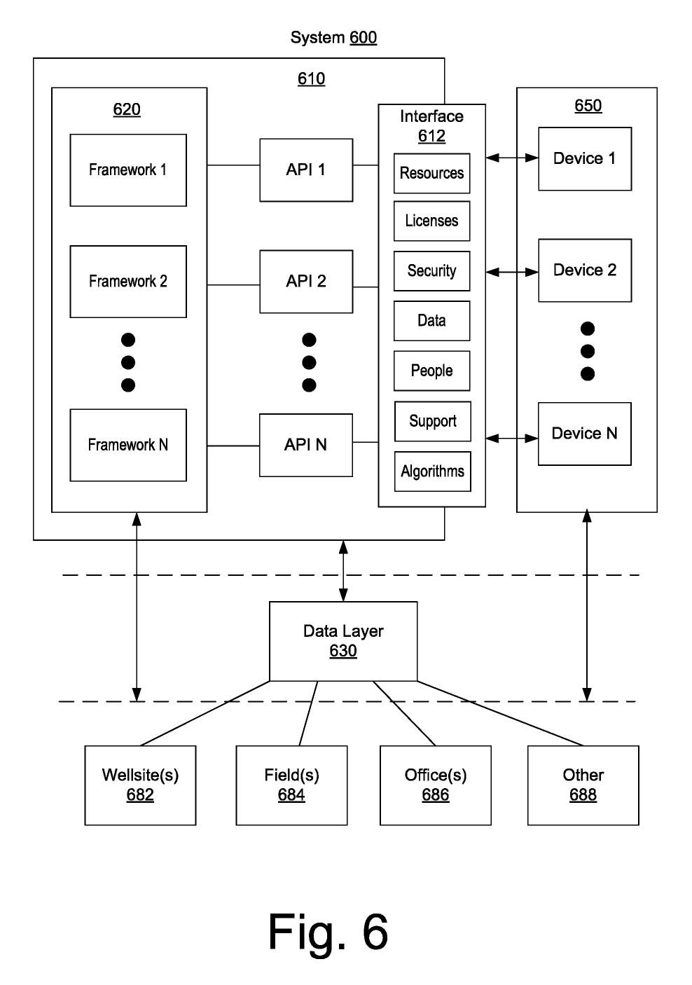

FIG. 6 shows an example of a system 600 that includes a cloud environment 610, frameworks 620, a data layer 630, devices 650 and sites such as a wellsite 682, a field site 684, an office site 686 and one or more other types of sites 688.

In the example of FIG. 6, a common interface 612 exists for the cloud environment 610 that can receive information from the devices 650, which can include client devices and, for example, IoT devices. The cloud environment 610 can include particular APIs that are accessible via the common interface 612, which may correspond to particular frameworks.

As an example, one of the devices 650 may be an iOS® OS device such as an iPHONE® smartphone. In such an example, an app written for the OS may execute on the smartphone. The app can include an instruction set that can transmit API calls to the common interface 612 where the common interface 612 can parse the API calls to appropriately instruct resources (e.g., services, etc.) of the cloud environment 610. In such an example, an API call may include sub-API calls that are parsed and transmitted to one or more particular APIs, which may be associated with one or more particular frameworks. In such an example, the cloud environment 610 can generate a response to one or more API calls received from the smartphone. As an example, a response may be generated by implementing one or more algorithms of the common interface 612, which may process information in a manner suitable for consumption by an app, a Web browser application, etc.

As an example, a response may be an image that can be rendered to a display of the smart phone. For example, consider an API call that is or includes a PETREL® framework API call to control a camera in a 3D visualization of an earth model. In such an example, the API call may instruct an instance of the PETREL® framework to alter the camera to a different view. The cloud environment 610 can utilize resources to adjust the view and generate image data corresponding to the view. In such an example, the view is not rendered where there is no corresponding physical display in the cloud environment 610. Rather, image data are generated in a format suitable for transmission to the smartphone to render the view. In such an example, the image data may be a bitmap, JPEG or other format. As an example, where the smartphone includes a graphics package, some graphics information may be transmitted. As an example, consider a pdf image that is a vector pdf image being generated by the cloud environment 610 and transmitted to the smartphone for rendering to a display of the smartphone using a pdf application (e.g., pdf reader). In such an approach, data bandwidth demands and timings associated with transmission may be reduced, which may be beneficial where the smartphone is at a site that may be unstable or low bandwidth as to network communications (e.g., via the communication circuitry of the smartphone).

As shown in the example of FIG. 6, the cloud environment 610 may provide for access to the data layer 630. For example, one of the devices 650 may request data that can be handled via the cloud environment 610 according to capabilities of the common interface 612.

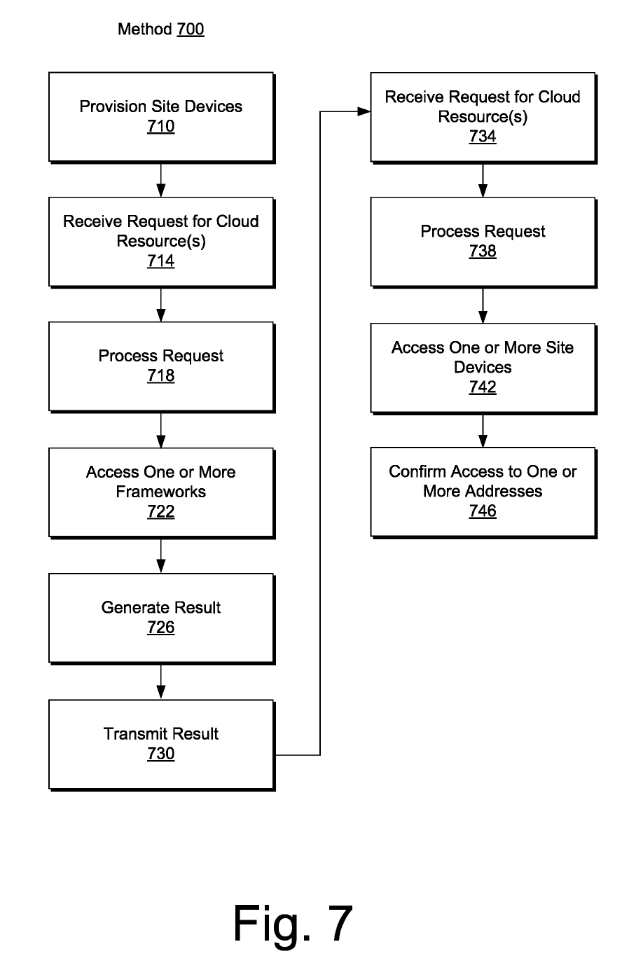

FIG. 7 shows an example of a method 700 that includes a provision block 710 for provisioning site devices at a field site, a reception block 714 for receiving a request for one or more cloud resources, a process block 718 for processing the request, an access block 722 for accessing one or more frameworks, a generation block 726 for generating a result based at least in part on accessing one or more frameworks, a transmission block 730 for transmitting the results, another reception block 734 for receiving a request for one or more cloud resources, a process block 738 for processing the request, an access block 742 for accessing one or more of the provisioned site devices based at least in part on the request and a confirmation block 746 for confirming to one or more addresses that the one or more site devices has been accessed. In such an example, the confirmation may be transmitted to one or more addresses, which can correspond to one or more account holders and/or one or more devices (e.g., client devices, etc.). As an example, an address may be an email address, an instant messaging address, an IP address, a MAC address, etc.

The method 700 demonstrates how interactions may occur with respect to site devices and frameworks via a cloud environment. In such an example, a user of a device (e.g., a client device) may be on-site or off-site. As an example, where an interruption in network communication occurs, a cloud platform can manage such an interruption such that when communication is re-established, a user of a device can pick-up a workflow at a suitable point, which may be where the interruption occurred.

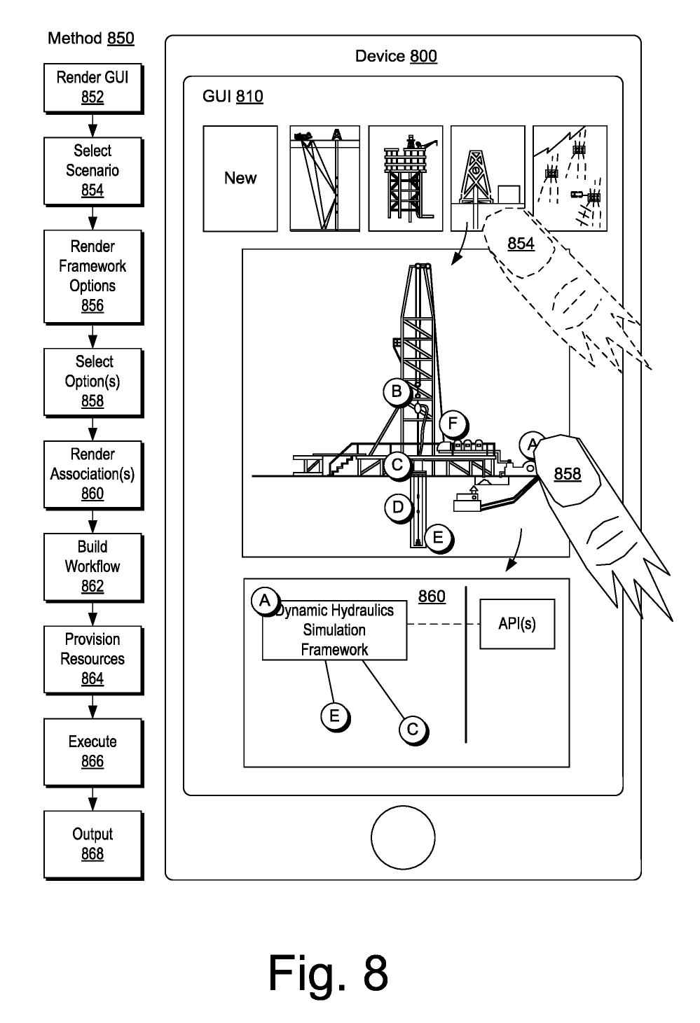

FIG. 8 shows an example of a device 800, an example of a graphical user interface 810 rendered to a display of the device 800 and an example of a method 850. As shown, the device 800 may be a client device associated with a client layer of a cloud architecture (see, e.g., the client layer 310 of FIG. 3). The device 800 can include one or more network interfaces that allow for an operating system environment established on the device 800 via one or more processors and operating system instructions stored in memory of the device 800 to access the Internet, directly or indirectly. As an example, the device 800 can include an app (e.g., particular application code instructions) and/or a browser application. Such applications can allow the device 800 to render information to a display, which may be, for example, a touchscreen display.

As an example, the device 800 can include a trusted platform module (TPM). A TPM may adhere to an international standard for a secure cryptoprocessor. A cryptoprocessor can be a dedicated microcontroller designed to secure hardware by integrating cryptographic keys into a device. As an example, access to a cloud environment may be via a security mechanism that may include accessing a TPM. As an example, a TPM may be utilized for one or more licenses that may correspond to one or more frameworks, one or more sites (e.g., field sites), etc.

As shown in the example of FIG. 8, the GUI 810 includes a series of graphics that represent different types of scenarios. For example, consider a seismic survey scenario, an offshore rig scenario, an on-shore rig scenario and a hydraulic fracturing scenario. As an example, a “new” graphic control may allow for selection of another scenario and/or creation of another scenario. As an example, the graphics of scenarios may be scrollable (e.g., horizontally and/or vertically). As an example, the device 800 may receive scenario information based at least in part on the location of the device 800, which may be determined, for example, via one or more techniques (e.g., network information, location circuitry such as GPS, etc.). In such an example, information may be transmitted to the device 800 via one or more networks to render a scenario graphic or graphics that are associated with a determined location of the device 800.

In the example of FIG. 8, an on-shore rig scenario has been selected as indicated by rendering of a larger graphic to the display of the device 800. In the example of FIG. 8, the graphic is rendered with graphic controls that may be associated with particular frameworks, which can include simulation frameworks. In such an example, input may be received to select one or more of the graphic controls to understand what types of frameworks are available for the selected scenario. For example, graphics shown in the GUI 810 of FIG. 8 include a drilling fluid graphic A, along with other graphics, labeled B, C, D, E and F. Each of the graphics can correspond to a framework and/or other resources that may be available in a cloud environment.

As shown in FIG. 8, input is received for the drilling fluid graphic A and, in response, a corresponding framework graphic is rendered to a portion of the GUI 810, particularly a dynamic hydraulics simulation framework. In the example of FIG. 8, associations may be rendered such that a user can see which other frameworks may be interoperable with the selected framework. As an example, information associated with one or more APIs may also be rendered via the GUI 810. In such an example, a user may select the API(s) graphic to understand types of API calls that may be made and types of information that may be generated in response to such API calls. Such API(s) may include an API hierarchy that includes a common API that can parse API calls for APIs that can be directed to one or more frameworks. As an example, a common API may include one or more algorithms that receive information response to API calls transmitted to one or more frameworks to process such information for purposes of generating output that may be transmitted to a device or devices via one or more networks. For example, consider a workflow where a user selects A and E as associated frameworks where a common API can receive an API call and parse the API call to direct sub-calls, at least one to the framework A and at least one to the framework E. In response, the common API can wait for responses to both sub-calls and process the information to generate a result or results where at least one of the results can be a hybrid result that is based on information received from framework A and information received from framework E.

As to the dynamic hydraulics simulation framework, consider, as an example, the DRILLBENCH® framework, which can allow for one or more of integration of well paths directly from the PETREL® framework (e.g., consider A and C frameworks being the DRILLBENCH® and PETREL® frameworks), reading pore and fracture pressure from the TECH LOG® framework (e.g., consider A and E frameworks being the DRILLBENCH® and TECHLOG® frameworks), support for dual gradient drilling with a subsea pump, improved modeling of managed pressure drilling, can allow for strengthened dynamic surge and swab calculations, and kick analysis (e.g., to generate a kick sheet for operational rigsite use, based on robust well control modeling and simulation).

In FIG. 8, the method 850 includes a render block 852 for rendering a GUI to a display of a client device, a selection block 854 for selecting a scenario rendered to a display of a client device, a render block 856 for rendering framework options to a display as associated with the selected scenario, a selection block 858 for selecting one or more options, a render block 860 for rendering one or more associations for at least one of the one or more options, a build block 862 for building a workflow based at least in part on a selected option, a provision block 864 for provisioning at least some cloud-based resources for implementation of at least one option (e.g., consider a framework to be instantiated or otherwise utilized in a manner that executes on cloud-based resources), an execute block 866 for executing at least a portion of the built workflow as associated with the selected scenario and an output block 868 for outputting information that is based at least in part on the executing. In such an example, the information may be output to one or more addresses, which can be network associated addresses, email addresses, text message addresses, phone number addresses, equipment addresses, etc. Information may, for example, be received by the device 800 and rendered to its display. In response to such information, the device 800 may render one or more graphic controls that can be actuated to control one or more pieces of equipment at an on-shore rigsite. Where a scenario pertains to another type of operation or operations, the device 800 may similarly be utilized to receive information and optionally control equipment based at least in part on such information (e.g., a control setting, etc.) and/or an assessment of such information.

As an example, a workflow may involve maintenance and/or monitoring of equipment at a site. In such an example, information may be stored using cloud-based resources and transmitted to one or more devices as associated with a client layer. As an example, consider a scenario that involves equipment maintenance and utilization of a framework such as, for example, the AVOCET® framework.

As an example, a method can include streaming information from a cloud environment to one or more client devices as may be associated with a client layer of a cloud architecture.

As an example, a method can include creating an icon for rendering to a display of a client device, which may be associated with an app or a browser application. In such an example, the icon may be actuated as graphic control to cause the app or browser application to access resources in a cloud environment as to a workflow that may be previously developed and at least in part executed. In such an example, updates may be transmitted to the client device as to the workflow.

As an example, a method can include building a workflow that involves accessing a plurality of different frameworks. Such a workflow may be referred to as a hybrid framework workflow. Such a workflow can include one or more cloud-based API layers that can handle API calls and responses to such API calls. As an example, a software development kit (SDK) can be provided for the one or more API layers where such an SDK can allow for integration of one or more framework specific SDKs. As an example, a method can include transmitting two or more framework specific API calls to a cloud environment and receiving a result responsive to the API calls that is a result that is based in part on information specific to each of the two or more specific API calls. In such an example, an API layer of the cloud environment may generate such a result based on information received from two or more frameworks.

As an example, a method can include receiving a request for cloud resources where the cloud resources includes frameworks where the frameworks include a seismic interpretation and earth model framework; processing the request; accessing at least one of the frameworks as executing on at least a portion of the cloud resources; generating a result responsive to the accessing; and transmitting the result. In such an example, the request can be an application programming interface (API) call associated with at least one of the frameworks. As an example, the API call can be a common API call that is parsed into one or more sub-API calls. In such an example, a cloud-based common API can include one or more algorithms that can generate a result or results responsive to receipt of information from one or more different frameworks responsive to an API call received by the common API. In such an example, the common API may be a layer with associated resources that can receive and transmit information via one or more network interfaces.

As an example, a method can include receiving a request at a common interface of a cloud platform for the cloud resources. In such an example, the method can include processing the request by parsing the request for one or more API calls associated with at least one of the frameworks where such one or more API calls may be considered to be sub-API calls with respect to a call received by the common interface (e.g., a common API call that targets a common API layer).

As an example, a method can include provisioning site devices at a wellsite via a cloud platform for the cloud resources. In such an example, the method can include receiving a request to access one of the provisioned site devices at the wellsite. For example, consider a request to access one of the provisioned site devices at the wellsite where a control request can be to control the one of the provisioned devices. As an example, a control request is based at least in part on a transmitted result.

As an example, frameworks can include a borehole data framework. As an example, a seismic interpretation and earth model framework can be operatively coupled to a reservoir simulator.

As an example, a method can include generating a result as an image. For example, consider generating an image as a bitmap.

As an example, a method can include transmitting a result to one or more addresses.

As an example, a cloud platform for cloud resources can include a common interface as a proxy for a plurality of frameworks.

As an example, a cloud system can include servers where each of the servers includes a processor and memory accessible by the processor; data storage devices accessible by the servers; processor-executable framework instructions for a plurality of frameworks stored in the data storage devices where the frameworks include a seismic interpretation and earth model framework; processor-executable application programming interface instructions for the frameworks; and processor-executable common interface instructions for a common interface that is a proxy that exposes the frameworks to the Internet (e.g., exposed to the Web). In such an example, instructions can include processor-executable provisioning instructions for provisioning site devices. For example, consider site devices that include wellsite devices. As an example, site devices may include one or more seismic survey site devices. As an example, a system can include instructions that are processor-executable common interface instructions for a common interface that is a proxy that exposes provisioned site devices.

As an example, one or more computer-readable storage media can include processor-executable instructions executable to instruct a computing system to: receive a request for cloud resources where the cloud resources includes frameworks where the frameworks include a seismic interpretation and earth model framework; process the request; access at least one of the frameworks as executing on at least a portion of the cloud resources; generate a result responsive to the accessing; and transmitting the result.

As an example, a workflow may be associated with various computer-readable media (CRM) blocks. Such blocks generally include instructions suitable for execution by one or more processors (or cores) to instruct a computing device or system to perform one or more actions. As an example, a single medium may be configured with instructions to allow for, at least in part, performance of various actions of a workflow. As an example, a computer-readable medium (CRM) may be a computer-readable storage medium. A computer-readable storage medium is non-transitory, not a signal and not a carrier wave.

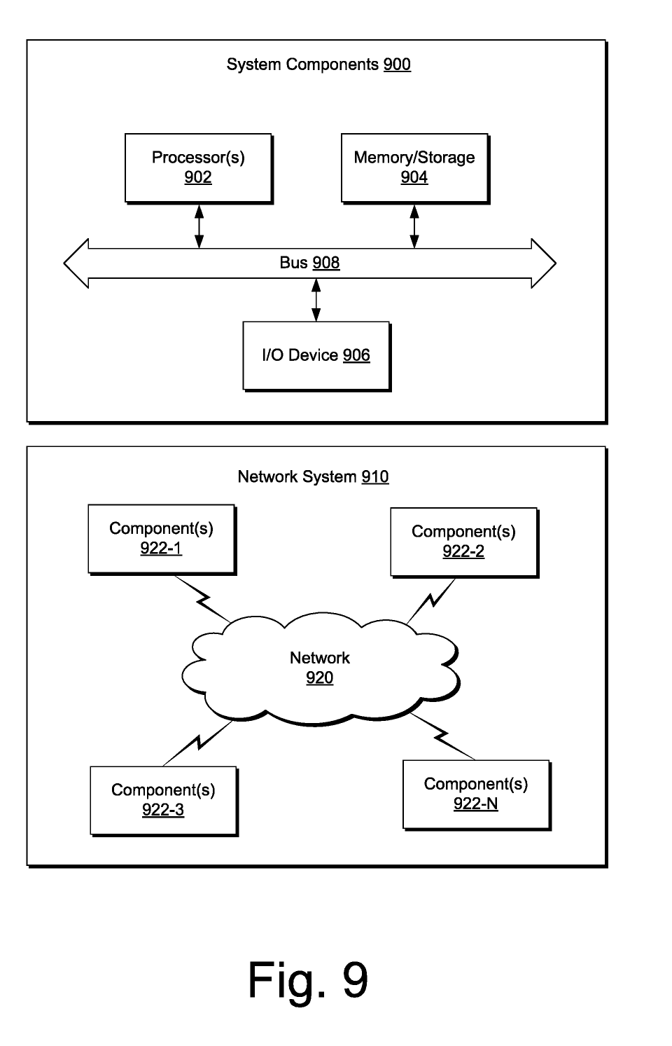

FIG. 9 shows components of an example of a computing system 900 and an example of a networked system 910. The system 900 includes one or more processors 902, memory and/or storage components 904, one or more input and/or output devices 906 and a bus 908. In an example embodiment, instructions may be stored in one or more computer-readable media (e.g., memory/storage components 904). Such instructions may be read by one or more processors (e.g., the processor(s) 902) via a communication bus (e.g., the bus 908), which may be wired or wireless. The one or more processors may execute such instructions to implement (wholly or in part) one or more attributes (e.g., as part of a method). A user may view output from and interact with a process via an I/O device (e.g., the device 906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 910. The network system 910 includes components 922-1, 922-2, 922-3, . . . 922-N. For example, the components 922-1 may include the processor(s) 902 while the component(s) 922-3 may include memory accessible by the processor(s) 902. Further, the component(s) 902-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

1.-15. (canceled)

16. A method comprising:
receiving a request for cloud resources wherein the cloud resources comprise frameworks wherein the frameworks comprise a seismic interpretation and earth model framework;
processing the request;
accessing at least one of the frameworks as executing on at least a portion of the cloud resources;
generating a result responsive to the accessing; and
transmitting the result.

17. The method of claim 16 wherein the request comprises an application programming interface (API) call associated with at least one of the frameworks.

18. The method of claim 16 wherein the receiving comprises receiving the request at a common interface of a cloud platform for the cloud resources.

19. The method of claim 18 wherein processing the request comprises parsing the request for one or more API calls associated with at least one of the frameworks.

20. The method of claim 16 comprising provisioning site devices at a wellsite via a cloud platform for the cloud resources.

21. The method of claim 20 comprising receiving a request to access one of the provisioned site devices at the wellsite.

22. The method of claim 21 wherein the request to access one of the provisioned site devices at the wellsite comprises a control request to control the one of the provisioned devices.

23. The method of claim 22 wherein the control request is based at least in part on the transmitted result.

24. The method of claim 16 wherein the frameworks comprise a borehole data framework.

25. The method of claim 16 wherein the seismic interpretation and earth model framework is operatively coupled to a reservoir simulator.

26. The method of claim 16 wherein the result comprises an image.

27. The method of claim 26 comprising generating the image as a bitmap.

28. The method of claim 16 wherein transmitting the result comprises transmitting the result to one or more addresses.

29. The method of claim 16 comprising a cloud platform for the cloud resources wherein the cloud platform comprises a common interface as a proxy for the frameworks.

30. A cloud system comprising:
servers wherein each of the servers comprises a processor and memory accessible by the processor;
data storage devices accessible by the servers;
processor-executable framework instructions for a plurality of frameworks stored in the data storage devices wherein the frameworks comprise a seismic interpretation and earth model framework;
processor-executable application programming interface instructions for the frameworks; and
processor-executable common interface instructions for a common interface that is a proxy that exposes the frameworks to the Internet.

31. The cloud system of claim 30 comprising processor-executable provisioning instructions for provisioning site devices.

32. The cloud system of claim 31 wherein the site devices comprise wellsite devices.

33. The cloud system of claim 31 wherein the site devices comprise seismic survey site devices.

34. The cloud system of claim 31 wherein the processor-executable common interface instructions for a common interface that is a proxy that exposes provisioned site devices.

35. One or more computer-readable storage media comprising processor-executable instructions executable to instruct a computing system to:
receive a request for cloud resources wherein the cloud resources comprise frameworks wherein the frameworks comprise a seismic interpretation and earth model framework;
process the request;
access at least one of the frameworks as executing on at least a portion of the cloud resources;
generate a result responsive to the accessing; and
transmitting the result.
